(19) United States
(12) Patent Application Publication
(10) Pub. No.: US 2015/0130905 A1
(43) Pub. Date: May 14, 2015

(54) 3D SHAPE MEASUREMENT APPARATUS

(71) Applicant: Kazuki Yamamoto, Kyoto-city (JP)

(72) Inventor: Kazuki Yamamoto, Kyoto-city (JP)

(21) Appl. No.: 14/382,368

(22) PCT Filed: Mar. 12, 2012
(86) PCT No.: PCT/JP2012/001689

§ 371 Date: Sep. 2, 2014

(51) Int. Cl. G02B 21/00; G02B 21/36; G02B 21/14; G01B 11/24

(52) U.S. Cl. CPC G02B 21/0004; G01B 11/24; G02B 21/361; G02B 21/14
USPC 348/46

(57) ABSTRACT

Provided is a 3D shape measurement apparatus that can obtain a phase delay distribution image of an object to be measured from a single image and has simple optics. The 3D shape measurement apparatus 1 includes a coherent light source 10, a random phase modulation optical system 11, a mount 12, a Fourier transform optical system 13, an image pickup device 14, and an operation part 15. The random phase modulation optical system 11 two-dimensionally and randomly phase-modulates the coherent light to produce two-dimensionally and randomly phase-modulated flat light. The Fourier transform optical system 13 optically Fourier-transforms the light having passed through the object 16 to be measured to generate a light intensity distribution image. The image pickup device 14 takes the light intensity distribution image. The operation part 15 computes phase information on the object 16 to be measured from the taken light intensity distribution image. The operation part 15 further calculates a 3D shape of the object 16 to be measured from the phase information.

### TECHNICAL FIELD

This invention relates to 3D shape measurement apparatuses.

### BACKGROUND ART

Atomic force microscopes and scanning electron microscopes are previously known as apparatuses that can measure a three-dimensional shape of a microscopic 3D object, such as a cell, with nanometer accuracy. However, with the use of an atomic force microscope or a scanning electron microscope, it is often necessary prior to measurement to subject a cell to a troublesome pretreatment, and the cell will suffer irreparable damage during measurement. Therefore, studies have been conducted on a variety of methods that can measure a three-dimensional shape of a microscopic 3D object, such as a cell, without damaging the object to be measured.

Examples of the above methods include phase-shifting interferometry and optical tomography. These methods, however, require multi-shot images and involve the computation of the multi-shot images.

On the other hand, with the use of, for example, a digital holographic microscope as described in Patent Literature 1 or an image holographic microscope, a phase delay distribution image of an object to be measured can be obtained from a single image. Specifically, with the use of a digital holographic microscope, a 3D shape of an object to be measured can be obtained by calculating the convolution of a diffraction wavefront upon application of a reference beam to a hologram produced by interference of an object beam with the reference beam.

With the use of an image holographic microscope, a phase delay distribution image of an object to be measured can be obtained by recording, as an image, interference fringes in which a disturbance component due to a phase delay of the object to be measured is superimposed on carrier fringes with a regularity formed by allowing a real image or a differential phase contrast image generated by focusing object light to interfere with reference light shifted in principal axis from the object light, and then removing a component of the carrier fringes and the disturbance by two-dimensional heterodyne detection.

### CITATION LIST

### Patent Literature

### [PTL 1] JP-A-2008-292939

### SUMMARY OF INVENTION

### Technical Problem

The digital holographic microscope and the image holographic microscope are microscopes using an inteferometer. Therefore, the optics in these microscopes has a complicated structure. Thus, their measurement results are significantly influenced by vibrations and air currents. With the use of these microscopes, the 3D shape of the object to be measured may not be able to be accurately measured.

A principal object of the present invention is to provide a 3D shape measurement apparatus that can obtain a phase delay distribution image of an object to be measured from a single image and has simple optics.

### Solution to Problem

A 3D shape measurement apparatus of the present invention includes a coherent light source, a random phase modulation optical system, a mount, a Fourier transform optical system, an image pickup device, and an operation part. The coherent light source emits coherent light. The random phase modulation optical system two-dimensionally and randomly phase-modulates the coherent light to produce two-dimensionally and randomly phase-modulated flat light. An object to be measured is to be mounted on the mount so that the two-dimensionally and randomly phase-modulated flat light passes through the object to be measured. The Fourier transform optical system optically Fourier-transforms the light having passed through the object to be measured to generate a light intensity distribution image. The image pickup device takes the light intensity distribution image. The operation part computes phase information on the object to be measured from the taken light intensity distribution image. The operation part calculates a 3D shape of the object to be measured from the phase information.

The random phase modulation optical system is preferably configured to perform a random phase modulation in which discrete values are in binary, ternary or quaternary form.

The random phase modulation optical system may include a spatial phase modulation filter.

The random phase modulation optical system may include a translucent plate having a gray scale image printed thereon, a condenser lens, and a spatial filter which are arranged in this order of proximity to the coherent light source.

The operation part includes a storage section, a phase image calculation section, a cross-correlation image calculation section, a quasi phase delay image calculation section, a singularity elimination section, and a 3D shape calculation section. The storage section stores a light intensity distribution image taken with the object to be measured not yet mounted and a light intensity distribution image taken with the object to be measured mounted. The phase image calculation section calculates a reference phase image restored in phase from the light intensity distribution image taken with the object to be measured not yet mounted. The phase image calculation section also calculates a measured phase image restored in phase from the light intensity distribution image taken with the object to be measured mounted. The cross-correlation image calculation section calculates a cross-correlation image by computing a cross-correlation function between the reference phase image and the measured phase image. The quasi phase delay image calculation section calculates a quasi phase delay image based on differences of values of elements of the cross-correlation image from a peak value of the cross-correlation image. The singularity elimination section eliminates singularities based on data on adjacent pixels to each of the elements of the quasi phase delay image to obtain a phase delay image. The 3D shape calculation section calculates a 3D shape of the object to be measured from the phase delay image.

The phase image calculation section may calculate the reference phase image by extending the light intensity distribution image taken with the object to be measured not yet mounted to complex space data, then forcing the least portion of real part image contained in the complex space data to be zero, and then restoring the phase by digital inverse Fourier transform, and calculate the measured phase image by extending the light intensity distribution image taken with the object to be measured mounted to complex space data, then forcing the real part of the complex space data to be zero, and then restoring the phase by digital inverse Fourier transform.

### Advantageous Effects of Invention

The present invention can provide a 3D shape measurement apparatus that can obtain a phase delay distribution image of an object to be measured from a single image and has simple optics.

### BRIEF DESCRIPTION OF DRAWINGS

FIG. 1 is a schematic block diagram of a 3D shape measurement apparatus of a first embodiment.

FIG. 2 is a schematic plan view of a random phase modulation optical system in the first embodiment.

FIG. 3 is a schematic cross-sectional view taken along the line in FIG. 2.

FIG. 4 is a schematic block diagram of an operation part in the first embodiment.

FIG. 5 is an example of a taken light intensity distribution image.

FIG. 6 is a schematic block diagram of a random phase modulation optical system in a second embodiment.

FIG. 7 is a schematic block diagram of a 3D shape measurement apparatus of a third embodiment.

### DESCRIPTION OF EMBODIMENTS

Hereinafter, a description will be given of exemplified preferred embodiments of the present invention. However, the following embodiments are simply illustrative. The present invention is not limited at all to the following embodiments.

Throughout the drawings to which the embodiments and the like refer, elements having substantially the same functions will be referred to by the same reference signs. The drawings to which the embodiments and the like refer are schematically illustrated and, therefore, the dimensional ratios and the like of objects illustrated in the drawings may be different from those of the actual objects. Different drawings may have different dimensional ratios and the like of the objects. Dimensional ratios and the like of specific objects should be determined in consideration of the following descriptions.

### First Embodiment

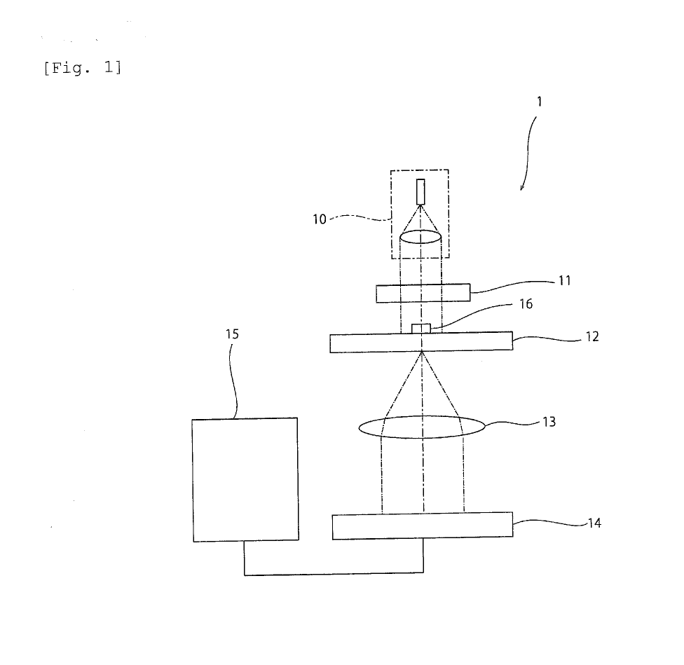

FIG. 1 is a schematic block diagram of a 3D shape measurement apparatus 1 of a first embodiment. The 3D shape measurement apparatus 1 is an apparatus that can measure a 3D shape, such as thickness, of a light-transmissive microscopic object to be measured, such as a cell, in a noncontact and optical manner. The 3D shape measurement apparatus 1 can perform real-time analysis of, for example, biological cell samples in a living condition without the need for pretreatment. Therefore, the 3D shape measurement apparatus 1 is effectively used in fields of, for example, drug discovery, health management, national security, food industry, prevention of pollen allergy and pandemic infectious diseases, monitoring of bioterrorism, and detection of bacterial contamination.

The 3D shape measurement apparatus 1 includes a coherent light source 10, a random phase modulation optical system 11, a mount 12, a Fourier transform optical system 13, an image pickup device 14, and an operation part 15. The random phase modulation optical system 11, the mount 12, and the Fourier transform optical system 13 are arranged in this order between the coherent light source 10 and the image pickup device 14.

The coherent light source 10 emits coherent light. The coherent light source 10 can be composed of, for example, a solid-state laser, a gas laser, a semiconductor laser or any other laser that can emit radiation resulting from laser oscillation. No particular limitation is placed on the wavelength of the coherent light source. The wavelength of the coherent light source can be appropriately selected from a wide range of wavelengths, for example, including ultraviolet light, visible light, infrared light, and near-infrared light.

The random phase modulation optical system 11 is disposed between the coherent light source 10 and the mount 12. The random phase modulation optical system 11 two-dimensionally and randomly phase-modulates the coherent light to produce two-dimensionally and randomly phase-modulated flat light.

The random phase modulation optical system 11 is a set of windows which are random in the amount of phase delay. The term “random” herein means a condition that the probabilities of occurrence of values capable of being taken by a sequence are equal or approximately equal. A power spectrum in the spatial frequency domain resulting from Fourier transform of a random sequence has no characteristic frequency. This means that the autocorrelation function is a delta function. The values capable of being taken by the sequence may be discrete values. The sequence may be defined by a non-deterministic random sequence or defined by a deterministic pseudo-random sequence. The amounts of phase delay of the windows in the random phase modulation optical system 11 are determined according to a random sequence.

The random phase modulation optical system 11 can be composed of, for example, a spatial phase modulation filter. Spatial phase modulation filters include a static spatial phase modulation element and a dynamic spatial phase modulation element. Specific examples of the static spatial phase modulation element include one including a transparent substrate and a plurality of dielectric layers arranged in matrix form on the transparent substrate and one formed of a stack of a plurality of transparent plates each having a plurality of through holes formed therein in matrix form.

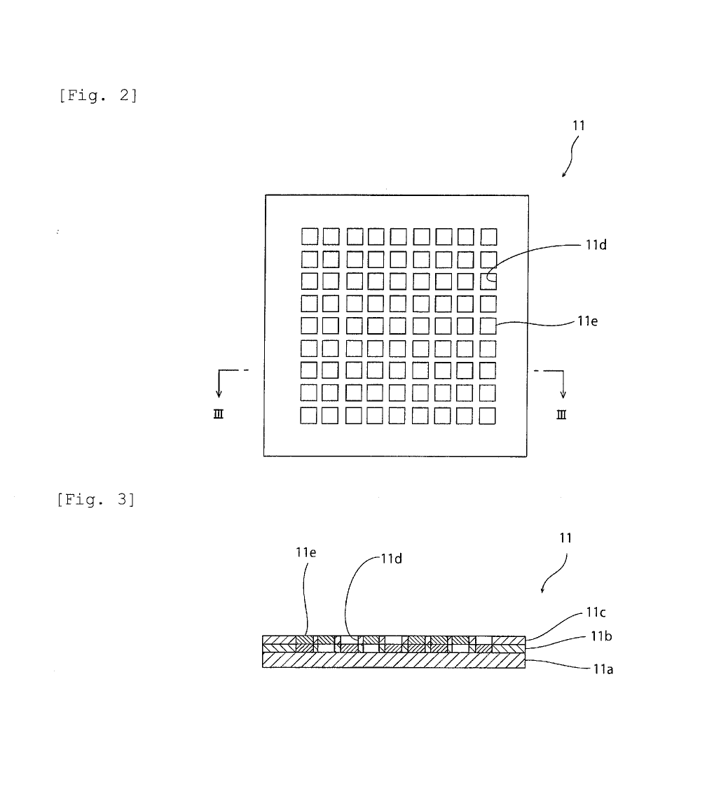

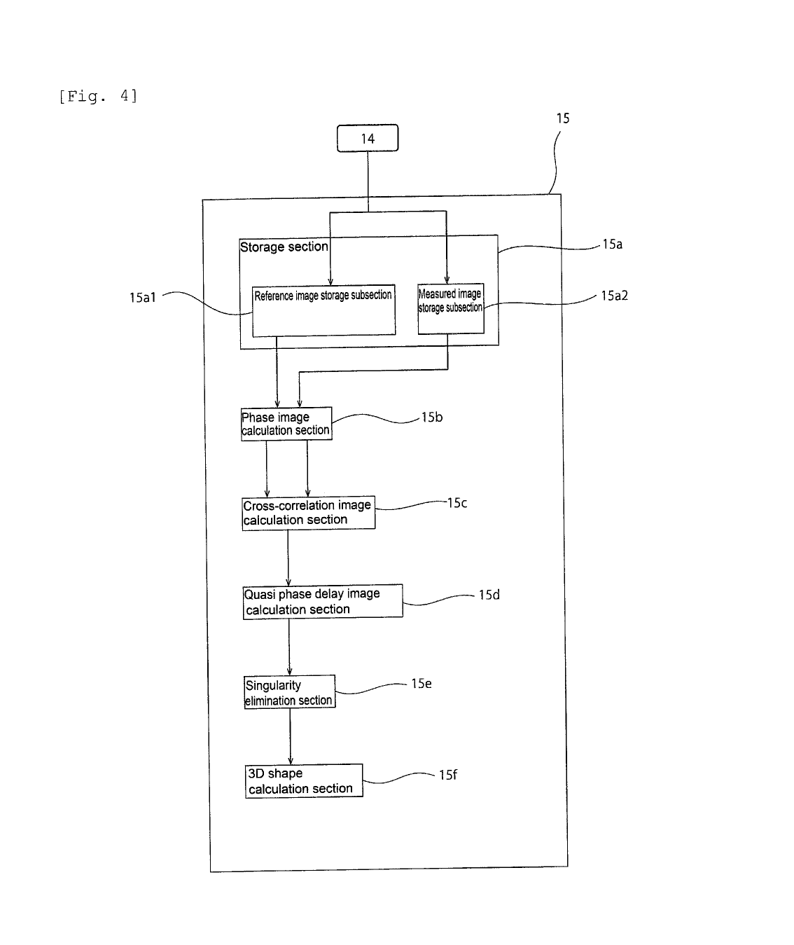

Specifically, in this embodiment, as shown in FIGS. 2 and 3, the random phase modulation optical system 11 includes stacked transparent substrates 11a to 11c. The transparent substrates 11b and 11c are each provided with a plurality of windows 11d in matrix form. Dielectric layers 11e are randomly arranged in the plurality of windows 11d. A gap may be provided between each pair of adjacent windows 11d.

The random phase modulation optical system 11 is preferably configured to perform a random phase modulation in which discrete values are in binary, ternary or quaternary form.

Although in this embodiment the shape of the window 11d is rectangular, it may be circular, polygonal or other shapes. The length of one side of the window 11d is preferably about three times to ten times the pixel pitch of the image pickup device 14. Thus, an self-interference hologram can be oversampled by the image pickup device 14 with a resolution exceeding the Nyquist criterion. For example, if a magnifying optical system is further provided ahead of or behind the Fourier transform optical system 13, the length of one side of the window 11d is preferably about three times to ten times the value obtained by dividing the pixel pitch of the image pickup device 14 by the magnification of the magnifying optical system. If it is difficult to process the random phase modulation optical system 11 into a desired small size, it is desirably used in combination with a reducing optical system.

A confocal optical system may be further disposed between the Fourier transform optical system 13 and the image pickup device 14. In this case, the measurement of a 3D shape can be suitably achieved even if the 3D shape measurement apparatus 1 is placed in a lighted environment.

If the values capable of being taken by a two-dimensional random phase modulation of a random phase light source composed of the coherent light source 10 and the random phase modulation optical system 11 are limited to binary values, the random phase modulation optical system 11 can be composed of, for example, a spatial phase modulation element disposed so that the phase delay of each window 11d takes −π/2 and +π/2 in correspondence with 0 and 1, respectively, of a deterministic pseudo-random binary sequence.

As a deterministic pseudo-random binary sequence, a recurring pseudo-random binary sequence can be suitably used which has a recurring period longer than the number of pixels along one side of the image pickup device used. If in a recurring pseudo-random binary sequence the member thereof is represented by m[n], the element by element product of m[n] and m[n−d1] cyclically shifted from m[n] by d1 gives a sequence m[n−d2] cyclically shifted from the original sequence m[n] by d2. In other words, the recurring pseudo-random binary sequence is defined as a sequence having the characteristic of m[n−d2]=m[n]m[n−d1]. A representative example of such a sequence is an M-sequence. The M-sequence is a 1-bit sequence generated from the following linear recurrence formula:

xₙ=xₙ₋ₚ+x_{n-q}(p>q) (1)

In this linear recurrence formula the value of each term is 0 or 1. The sign “+” represents an exclusive OR (XOR) operation. In other words, the n-th term can be obtained by XORing the n-p-th term and n-q-th term. For example, an M-sequence with a 2047 bit period is suitably used.

Examples of the recurring pseudo-random binary sequence includes, besides the M-sequence, a Gold sequence and other sequences.

If the values capable of being taken by the two-dimensional random phase modulation of the random phase light source are limited to ternary values, the random phase modulation optical system 11 can be, for example, one in which dielectric layers 11e with a thickness corresponding to a phase delay of one-third π form a stack composed of a first ply thereof arranged according to a certain recurring pseudo-random binary sequence M[0] and a second ply thereof arranged according to a sequence cyclically shifted by a few bits from M[0], for example, a sequence M[2] shifted by two bits from M[0].

If the values capable of being taken by the two-dimensional random phase modulation of the random phase light source are limited to quaternary values, the random phase modulation optical system 11 can be, for example, one in which dielectric layers 11e with a thickness corresponding to a phase delay of one-fourth π forma stack composed of a first ply thereof arranged according to a certain recurring pseudo-random binary sequence M[0], a second ply thereof arranged according to a sequence M[10], and a third ply thereof according to a sequence M[20].

In another embodiment, the static spatial phase modulation element can be formed by developing a photo polymer by exposure to light through an amplitude mask made on a clear film with an image setter. If the values capable of being taken by the two-dimensional random phase modulation of the random phase light source are limited to quaternary values, a quaternary random phase modulation filter can be formed in a single step using an amplitude mask according to a pseudo-random quaternary sequence.

As described previously, the random phase modulation optical system 11 may be composed of a dynamic spatial phase modulation element. An example of the dynamic spatial phase modulation element is a liquid-crystal spatial phase modulation element using a nematic liquid crystal or a ferroelectric liquid crystal. The liquid-crystal spatial phase modulation element is classified into a transmission type and a reflection type. The liquid-crystal spatial phase modulation element of the reflection type can be used in combination with a mirror, for example.

An object 16 to be measured having a translucency, such as a cell, is mounted on the mount 12. The mount 12 is placed so that two-dimensionally and randomly phase-modulated flat light passes through the object 16 to be measured. The two-dimensionally and randomly phase-modulated flat light is scattered through the object 16 to be measured, resulting in production of object light containing phase information on the object 16 to be measured.

The object light enters the Fourier transform optical system 13. The Fourier transform optical system 13 optically Fourier-transforms the object light. Thus, the object light is converted into a light beam based on a spatial frequency distribution. The light beam based on the spatial frequency distribution is projected on the image pickup device 14, so that a light intensity distribution image composed of the intensity component of the light beam is generated. The “light intensity distribution image” thus obtained is an self-interference hologram image containing a spatial frequency distribution component relating to the object to be measured, a white noise component resulting from the random phase modulation, and an self-interference component resulting from diffraction at the object to be measured.

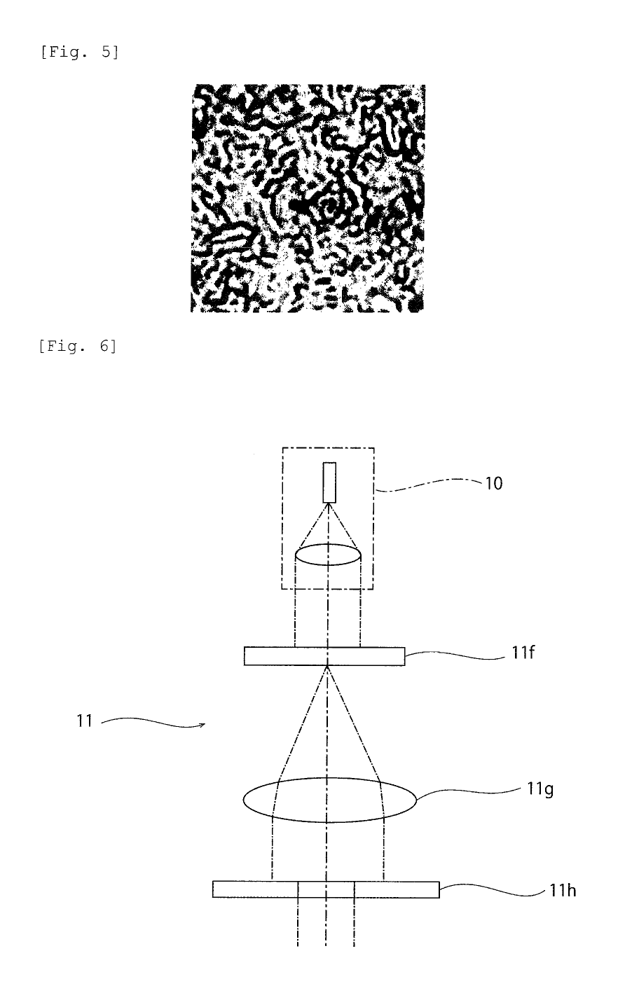

The light intensity distribution image is taken by the image pickup device 14. For example, the taken light intensity distribution image as shown in FIG. 5 is output from the image pickup device 14 to the operation part 15.

The operation part 15 computes phase information on the object 16 to be measured from the taken light intensity distribution image and calculates a 3D shape of the object 16 to be measured from the phase information.

Specifically, as shown in FIG. 4, the operation part 15 includes a storage section 15a, a phase image calculation section 15b, a cross-correlation image calculation section 15c, a quasi phase delay image calculation section 15d, a singularity elimination section 15e, and a 3D shape calculation section 15f.

The storage section 15a stores a light intensity distribution image taken with the object 16 to be measured not yet mounted and a light intensity distribution image taken with the object 16 to be measured mounted. For example, the storage section 15a may include a reference image storage subsection 15a1 for storing the light intensity distribution image taken with the object 16 to be measured not yet mounted and a measured image storage subsection 15a2 for storing the light intensity distribution image taken with the object 16 to be measured mounted. A light intensity distribution image taken as the object 16 to be measured not yet causing any particular change is mounted may be used as a reference image.

The phase image calculation section 15b calculates a reference phase image restored in phase from the reference image which is the light intensity distribution image taken with the object 16 to be measured not yet mounted. Furthermore, the phase image calculation section 15b calculates a measured phase image restored in phase from the measured image which is the light intensity distribution image taken with the object 16 to be measured mounted. An example of a phase restoration method is to extend the light intensity distribution image to complex space data, then force the real part of the complex space data to be zero, and then restore the phase by digital inverse Fourier transform. This phase restoration method given is illustrative only and the phase restoration method in the present invention is not limited to this. In the present invention, a repetitive phase restoration method using a convergence calculation may be used.

The cross-correlation image calculation section 15c calculates a cross-correlation image by computing a cross-correlation function between the reference phase image and the measured phase image. Specifically, the cross-correlation image calculation section 15c digitally Fourier-transforms a complex image whose imaginary part is a phase-restored reference phase image and whose real part is normalized to a constant, thereby obtaining a first Fourier-transformed complex image. The cross-correlation image calculation section 15c also digitally Fourier-transforms a complex image whose imaginary part is a phase-restored measured phase image and whose real part is normalized to a constant, thereby obtaining a second Fourier-transformed complex image. Furthermore, the cross-correlation image calculation section 15c computes the element by element product of the first and second Fourier-transformed complex images and subjects the product to digital inverse Fourier transform to determine a cross-correlation image. Prior to the calculation of a cross-correlation function, a low-frequency image filtering may be optionally added.

The quasi phase delay image calculation section 15d calculates a quasi phase delay image based on differences of values of elements of the cross-correlation image from a peak value of the cross-correlation image. Specifically, in the quasi phase delay image calculation section 15d, the arccosines of pixels of an image formed of differences of values of pixels of the cross-correlation image from the peak value of the cross-correlation image gives a quasi phase delay image of the object 16 to be measured. The quasi phase delay image is folded between −pi and +pi. Therefore, the quasi phase delay image has discrete singularities.

The singularity elimination section 15e conducts a phase unwrapping process to eliminate singularities based on data on adjacent pixels to each element of the quasi phase delay image, thereby obtaining a phase delay image. The phase unwrapping process used herein is the same as a phase unwrapping process carried out in image holography or for an interferometric synthetic aperture radar. Known specific examples of the phase unwrapping process include a branch-cut process (Goldstein et al., 1988) and a CN-ML process (Hiramatsu, 1992).

The 3D shape calculation section 15f calculates a 3D shape of the object 16 to be measured from the phase delay image. Specifically, the 3D shape calculation section 15f converts the phase delay information to thickness information in consideration of data on the refractive index of a liquid into which the object 16 to be measured is immersed and other data.

As described so far, the 3D shape measurement apparatus 1 is provided with a random phase modulation optical system for two-dimensionally and randomly phase-modulating coherent light, and randomly phase-modulated low-coherent flat light enters the object 16 to be measured. Therefore, object light having a phase distribution in which two-dimensional phase delay information on the object 16 to be measured is added to a two-dimensionally phase-modulated signal is projected as an self-interference hologram on the image pickup device 14 by the Fourier transform optical system 13 and recorded as a light intensity distribution image. Hence, reference light that would be required for a digital holographic microscope and image holography is not necessary. Thus, there is no need to provide any interferometer. Therefore, in the 3D shape measurement apparatus 1, the configuration of optics can be simplified. Since the 3D shape measurement apparatus 1 has a simple optics configuration, measurement is less influenced by vibrations and air currents, so that the 3D shape can be measured with high accuracy. Furthermore, since the apparatus 1 is based on the processing for obtaining a cross-correlation function, it will not matter if a slight gap exists between positions upon recording of the reference image and recording of the measured image. Therefore, the apparatus 1 can be applied to applications traveling through a large number of wells.

As seen from the above, the 3D shape measurement apparatus 1 can obtain a phase delay distribution image of the object to be measured from a single image while having very simple optics, and can measure a microscopic displacement and a 3D shape of the object to be measured in real time and in a non-contact manner.

Other preferred embodiments of the present invention will be described below. Throughout the description below, elements having functions substantially common to those of elements of the first embodiment will be referred to by the same reference signs and further explanation thereof will be accordingly omitted.

### Second Embodiment

FIG. 6 is a schematic block diagram of a random phase modulation optical system in a second embodiment.

As shown in FIG. 6, the random phase modulation optical system 11 may include a translucent plate 11f having a gray scale image printed thereon, a condenser lens 11g, and a spatial filter 11h which are arranged in this order of proximity to the coherent light source 10. The gray scale image printed on the translucent plate 11f is preferably obtained by estimating it from complex image data representing characteristics of a desired random phase light source by inverse operation using digital inverse Fourier transform or like techniques.

### Third Embodiment

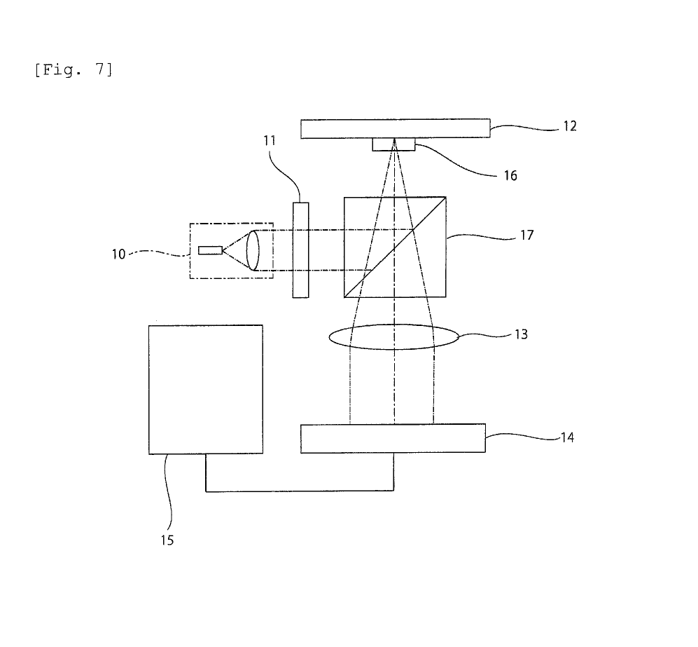

FIG. 7 is a schematic block diagram of a 3D shape measurement apparatus of a third embodiment.

As shown in FIG. 7, the 3D shape measurement apparatus may include a refraction optical system including a beam splitter 17 or the like.

### REFERENCE SIGNS LIST

1 . . . 3D shape measurement apparatus
10 . . . Coherent light source
11 . . . Random phase modulation optical system
11a to 11c . . . Transparent substrate
11d . . . Window
11e . . . Dielectric layer
11f . . . Translucent plate with a gray scale image printed thereon
11g . . . Condenser lens
11h . . . Spatial filter
12 . . . Mount
13 . . . Fourier transform optical system
14 . . . Image pickup element
15 . . . Operation part
15a . . . Storage section
15a1 . . . Reference image storage subsection
15a2 . . . Measured image storage subsection
15b . . . Phase image calculation section
15c . . . Cross-correlation image calculation section
15d . . . Quasi phase delay image calculation section
15e . . . Singularity elimination section
15f . . . 3D shape calculation section
16 . . . Object to be measured
17 . . . Beam splitter

1. A 3D shape measurement apparatus comprising:
a coherent light source for emitting coherent light;
a random phase modulation optical system for two-dimensionally and randomly phase-modulating the coherent light to produce two-dimensionally and randomly phase-modulated flat light;
a mount on which an object to be measured is to be mounted so that the two-dimensionally and randomly phase-modulated flat light passes through the object to be measured;
a Fourier transform optical system for optically Fourier-transforming the light having passed through the object to be measured to generate a light intensity distribution image;
an image pickup device for taking the light intensity distribution image; and
an operation part for computing phase information on the object to be measured from the taken light intensity distribution image and calculating a 3D shape of the object to be measured from the phase information,
wherein the operation part comprises:
a storage section for storing a light intensity distribution image taken with the object to be measured not yet mounted and a light intensity distribution image taken with the object to be measured mounted;
a phase image calculation section for calculating a reference phase image restored in phase from the light intensity distribution image taken with the object to be measured not yet mounted and calculating a measured phase image restored in phase from the light intensity distribution image taken with the object to be measured mounted;
a cross-correlation image calculation section for calculating a cross-correlation image by computing a cross-correlation function between the reference phase image and the measured phase image;
a quasi phase delay image calculation section for calculating a quasi phase delay image based on differences of values of elements of the cross-correlation image from a peak value of the cross-correlation image;
a singularity elimination section for eliminating singularities based on data on adjacent pixels to each of the elements of the quasi phase delay image to obtain a phase delay image; and
a 3D shape calculation section for calculating a 3D shape of the object to be measured from the phase delay image.

2. The 3D shape measurement apparatus according to claim 1, wherein the random phase modulation optical system is configured to perform a random phase modulation in which discrete values are in binary, ternary or quaternary form.

3. The 3D shape measurement apparatus according to claim 1, wherein the random phase modulation optical system includes a spatial phase modulation filter.

4. The 3D shape measurement apparatus according to claim 1, wherein the random phase modulation optical system includes a translucent plate having a gray scale image printed thereon, a condenser lens, and a spatial filter which are arranged in this order of proximity to the coherent light source.

5. (canceled)

6. The 3D shape measurement apparatus according to claim 1, wherein the phase image calculation section calculates the reference phase image by extending the light intensity distribution image taken with the object to be measured not yet mounted to complex space data, then forcing the real part of the complex space data to be zero, and then restoring the phase by digital inverse Fourier transform, and calculates the measured phase image by extending the light intensity distribution image taken with the object to be measured mounted to complex space data, then forcing the real part of the complex space data to be zero, and then restoring the phase by digital inverse Fourier transform.

7. The 3D shape measurement apparatus according to claim 2, wherein the random phase modulation optical system includes a spatial phase modulation filter.

8. The 3D shape measurement apparatus according to claim 2, wherein the random phase modulation optical system includes a translucent plate having a gray scale image printed thereon, a condenser lens, and a spatial filter which are arranged in this order of proximity to the coherent light source.

9. The 3D shape measurement apparatus according to claim 2, wherein the phase image calculation section calculates the reference phase image by extending the light intensity distribution image taken with the object to be measured not yet mounted to complex space data, then forcing the real part of the complex space data to be zero, and then restoring the phase by digital inverse Fourier transform, and calculates the measured phase image by extending the light intensity distribution image taken with the object to be measured mounted to complex space data, then forcing the real part of the complex space data to be zero, and then restoring the phase by digital inverse Fourier transform.

10. The 3D shape measurement apparatus according to claim 3, wherein the phase image calculation section calculates the reference phase image by extending the light intensity distribution image taken with the object to be measured not yet mounted to complex space data, then forcing the real part of the complex space data to be zero, and then restoring the phase by digital inverse Fourier transform, and calculates the measured phase image by extending the light intensity distribution image taken with the object to be measured mounted to complex space data, then forcing the real part of the complex space data to be zero, and then restoring the phase by digital inverse Fourier transform.

11. The 3D shape measurement apparatus according to claim 4, wherein the phase image calculation section calculates the reference phase image by extending the light intensity distribution image taken with the object to be measured not yet mounted to complex space data, then forcing the real part of the complex space data to be zero, and then restoring the phase by digital inverse Fourier transform, and calculates the measured phase image by extending the light intensity distribution image taken with the object to be measured mounted to complex space data, then forcing the real part of the complex space data to be zero, and then restoring the phase by digital inverse Fourier transform.

12. The 3D shape measurement apparatus according to claim 7, wherein the phase image calculation section calculates the reference phase image by extending the light intensity distribution image taken with the object to be measured not yet mounted to complex space data, then forcing the real part of the complex space data to be zero, and then restoring the phase by digital inverse Fourier transform, and calculates the measured phase image by extending the light intensity distribution image taken with the object to be measured mounted to complex space data, then forcing the real part of the complex space data to be zero, and then restoring the phase by digital inverse Fourier transform.

13. The 3D shape measurement apparatus according to claim 8, wherein the phase image calculation section calculates the reference phase image by extending the light intensity distribution image taken with the object to be measured not yet mounted to complex space data, then forcing the real part of the complex space data to be zero, and then restoring, the phase by digital inverse Fourier transform, and calculates the measured phase image by extending the light intensity distribution image taken with the object to be measured mounted to complex space data, then forcing the real part of the complex space data to be zero, and then restoring the phase by digital inverse Fourier transform.
